(19) United States
(12) Patent Application Publication
(10) Pub. No.: US 2013/0171484 A1
(43) Pub. Date: Jul. 4, 2013

(54) Materials and Methods for Autonomous Battery Shutdown

(71) Applicants: Marta B. Baginska, Urbana, IL (US); Benjamin J. Blaiszik, Urbana, IL (US); Aaron Esser-Kahn, Champaign, IL (US); Susan A. Odom, Champaign, IL (US); Wei Weng, Woodridge, IL (US); Zhengcheng Zhang, Naperville, IL (US); Nancy R. Sottos, Champaign, IL (US); Scott R. White, Champaign, IL (US); Jeffrey S. Moore, Savoy, IL (US); Khalil Amine, Oak Brook, IL (US)

(72) Inventors: Marta B. Baginska, Urbana, IL (US); Benjamin J. Blaiszik, Urbana, IL (US); Aaron Esser-Kahn, Champaign, IL (US); Susan A. Odom, Champaign, IL (US); Wei Weng, Woodridge, IL (US); Zhengcheng Zhang, Naperville, IL (US); Nancy R. Sottos, Champaign, IL (US); Scott R. White, Champaign, IL (US); Jeffrey S. Moore, Savoy, IL (US); Khalil Amine, Oak Brook, IL (US)

(73) Assignee: The Board of Trustees of the University of Illinois, Urbana, IL (US)

(21) Appl. No.: 13/489,871

(22) Filed: Jun. 6, 2012

Related U.S. Application Data
(60) Provisional application No. 61/493,673, filed on Jun. 6, 2011.

(51) Int. Cl. H01M 10/056; H01M 10/0525

(52) U.S. Cl. CPC H01M 10/056; H01M 10/0525
USPC 429/62

(57) ABSTRACT

An autonomous battery shutdown system includes a battery including an anode and a cathode, and an electrolyte composition between the anode and the cathode. The electrolyte composition includes an ionically conductive liquid containing lithium ions, and temperature-sensitive particles including a polymer having a melting temperature between 60° C. and 120° C. When the temperature of the battery exceeds 120° C., the temperature-sensitive particles form an ion barrier that traverses the battery. The resulting shutdown battery may have a specific charge capacity that is more than 98% lower than the specific charge capacity of the original battery.

### REFERENCE TO RELATED APPLICATIONS

This application claims the benefit of U.S. Provisional Application No. 61/493,673 entitled “Materials and Methods for Autonomous Battery Shutdown” filed Jun. 6, 2011, which is incorporated by reference in its entirety.

### FEDERALLY SPONSORED RESEARCH OR DEVELOPMENT

This invention was made with government support under contract number(s) DE-AC0206CH11357, ANL 9F 31921, and 392 NSF CHE 09-36888 FLLW ARRA, awarded by the Department of Energy and the National Science Foundation ACC Fellowship. The government has certain rights in the invention.

### BACKGROUND

Li-ion batteries are preferred for certain power applications due to their high specific energy density, lack of memory effect, and long cycle life. Currently, Li-ion batteries are predominantly used in consumer electronics. The presence of a combustible electrolyte and an oxidizing agent (lithium oxide cathode) in Li-ion batteries makes the batteries particularly susceptible to fires and explosions. Thermal overheating, electrical overcharging, or mechanical damage can trigger thermal runaway and, when left unchecked, combustion of battery materials.

When a Li-ion battery exceeds a critical temperature (ca. 150° C.), exothermic chemical reactions are initiated between the electrodes and the electrolyte, raising the battery's internal temperature. The increased temperature accelerates these chemical reactions, producing more heat through a dangerous positive feedback mechanism that leads to thermal runaway. The onset temperature of thermal runaway in Li-ion batteries decreases with increasing state of charge, making fully charged batteries even more susceptible to explosive failure.

Improvements in safety are likely necessary to provide more widespread acceptance of Li-ion batteries, such as in transportation applications (i.e. hybrid electric vehicles or aerospace applications). Various approaches have been investigated to prevent catastrophic thermal failure in Li-ion batteries. In one example, positive temperature coefficient (PTC) elements exhibit a large increase in resistance upon thermal activation, halting the flow of current at the battery terminal. In another example, shutdown separators rely on a phase change mechanism to limit ionic transport via formation of an ion-impermeable layer between the electrodes.

Shutdown separators typically contain a poly(ethylene)(PE)-polypropylene(PP) bilayer or a PP-PE-PP trilayer structure where the porous PE layer is thermally triggered to soften and to collapse the film pores, shutting down the cell by preventing ionic conduction, while the PP layer provides mechanical support. When the internal cell temperature rises to the softening temperature of the separator, the separator shrinks because of the difference in the density between the crystalline and amorphous phases of the separator materials. In a PP-PE-PP trilayer structure, there is a buffer of only 35° C. between the melting point of PE (130° C.) and the melting point of PP (165° C.). In some cases, the battery temperature can continue to increase after shutdown as a result of thermal inertia, causing the separator to fail and exposing the electrodes to internal shorting. In some cases, cells with a shutdown separator remain shutdown for as little as 3 min before failing due to internal shorting. Other shutdown separators that have been investigated include separators having a layer of wax-coated fabric where the wax on the fabric melts to close separator pores, and separators in contact with sintered wax particles.

Other approaches to prevent catastrophic thermal failure in Li-ion batteries also have been investigated. Examples of these approaches include electrolyte additives, thermally stable electrode materials, and electrolytes capable of thermally-triggered cross-linking. As with the shutdown separators, these attempts have met with mixed success.

It is desirable to provide a battery shutdown system that autonomously shuts down the battery at temperatures above those encountered during normal storage and use, but below those at which catastrophic thermal failure or thermal runaway occur. Preferably, such a system does not inhibit the charging and discharging of the battery during normal use.

### SUMMARY

In one aspect, the invention provides an autonomous battery shutdown system that includes a battery including an anode, a cathode, and an electrolyte composition between the anode and the cathode. The electrolyte composition includes an ionically conductive liquid containing lithium ions, and a plurality of temperature-sensitive particles including a polymer having a melting temperature between 60° C. and 120° C., where the temperature-sensitive particles have a hydrophilic surface. When the temperature of the battery exceeds 120° C., the temperature-sensitive particles form an ion barrier that traverses the battery.

In another aspect of the invention, there is an autonomous battery shutdown system that includes a battery including an anode, a cathode, and an electrolyte composition between the anode and the cathode. The electrolyte composition includes an ionically conductive liquid containing lithium ions, and a plurality of capsules having a capsule wall having a melting temperature between 60° C. and 120° C., and a barrier-forming agent enclosed by the capsule wall. When the temperature of the battery exceeds 120° C., the capsule wall melts, the barrier-forming substance is released, and the released barrier-forming substance forms an ion barrier that traverses the battery.

In another aspect of the invention, there is an autonomous battery shutdown system that includes a battery including an anode, a cathode, and an electrolyte composition between the anode and the cathode. The electrolyte composition includes an ionically conductive liquid containing lithium ions, a plurality of temperature-sensitive particles including a first polymer having a melting temperature between 60° C. and 120° C., and a plurality of thermally stable particles. When the temperature of the battery exceeds 120° C., the temperature-sensitive particles form an ion barrier that traverses the battery.

To provide a clear and more consistent understanding of the specification and claims of this application, the following definitions are provided.

The term “polymer” means a substance containing more than 100 repeat units. The term “polymer” includes soluble and/or fusible molecules having long chains of repeat units, and also includes insoluble and infusible networks. The term “prepolymer” means a substance containing less than 100 repeat units and that can undergo further reaction to form a polymer.

The term “capsule” means a closed object having a capsule wall enclosing an interior volume that may contain a solid, liquid, gas, or combinations thereof, and having an aspect ratio of 1:1 to 1:10. The aspect ratio of an object is the ratio of the shortest axis to the longest axis, where these axes need not be perpendicular. A capsule may have any shape that falls within this aspect ratio, such as a sphere, a toroid, or an irregular ameboid shape. The surface of a capsule may have any texture, for example rough or smooth.

The term “barrier-forming agent” means a substance that forms an ion barrier, either alone or when contacted with another substance.

The term “ion barrier” means a substance that has an ionic conductivity that is sufficiently low as to reduce the initial specific discharge capacity of a lithium ion battery it traverses to a level of 10% or less of the specific discharge capacity of a comparable lithium ion battery that does not include the ion barrier.

The term “polymerizer” means a composition that will form a polymer when it comes into contact with a corresponding activator for the polymerizer. Examples of polymerizers include monomers of polymers, such as styrene, ethylene, acrylates, methacrylates, and cyclic olefins such as dicyclopentadiene (DCPD) and cyclooctatetraene (COT); one or more monomers of a multi-monomer polymer system, such as diols, diamines and epoxides; prepolymers such as partially polymerized monomers still capable of further polymerization; and functionalized polymers capable of forming larger polymers or networks.

The term “activator” means anything that, when contacted or mixed with a polymerizer, will form a polymer. Examples of activators include catalysts and initiators. A corresponding activator for a polymerizer is an activator that, when contacted or mixed with that specific polymerizer, will form a polymer.

The term “catalyst” means a compound or moiety that will cause a polymerizable composition to polymerize, and that is not always consumed each time it causes polymerization. This is in contrast to initiators, which are always consumed at the time they cause polymerization. Examples of catalysts include ring opening metathesis polymerization (ROMP) catalysts such as Grubbs catalyst. Examples of catalysts also include silanol condensation catalysts such as titanates and dialkyltincarboxylates. A corresponding catalyst for a polymerizer is a catalyst that, when contacted or mixed with that specific polymerizer, will form a polymer.

The term “initiator” means a compound or moiety that will cause a polymerizable composition to polymerize and, in contrast to a catalyst, is always consumed at the time it causes polymerization. Examples of initiators include peroxides, which can form a radical to cause polymerization of an unsaturated monomer; a monomer of a multi-monomer polymer system, such as a diol, a diamine, and an epoxide; and amines, which can form a polymer with an epoxide. A corresponding initiator for a polymerizer is an initiator that, when contacted or mixed with that specific polymerizer, will form a polymer.

The term “shutdown” with respect to a lithium ion battery means a loss of more than 98% of the initial specific charge capacity.

### BRIEF DESCRIPTION OF THE DRAWINGS

The invention can be better understood with reference to the following drawings and description. The components in the figures are not necessarily to scale and are not intended to accurately represent molecules or their interactions, emphasis instead being placed upon illustrating the principles of the invention. Moreover, in the figures, like referenced numerals designate corresponding parts throughout the different views.

FIG. 1 depicts a schematic representation of an autonomous battery electrolyte shutdown system.

FIG. 2 is a histogram of the measured particle diameters, and the inset depicts a scanning electron microscopy (SEM) image of the PE particles.

FIG. 3 is a graph of electrode surface coverage as a function of spin coating rotational speed for PE particle suspensions having various particle concentrations, and the inset depicts an optical micrograph of an anode surface after spin coating with a 30 wt % PE particle suspension at 3,000 rpm.

FIG. 4 is a graph of separator surface coverage as a function of spin coating rotational speed for PE particle suspensions having various particle concentrations.

FIGS. 5A-5C are graphs of voltage and current over time for cells containing a conventional separator at room temperature (5A), and after thermal testing at 110° C. (5B) or at 135° C. (5C).

FIGS. 6A-6C are graphs of voltage and current over time for cells containing temperature-sensitive PE particles and a conventional separator at room temperature (6A), and after thermal testing at 110° C. (6B) or at 135° C. (6C).

FIGS. 7A and 7B are graphs of specific charge capacity (7A) and of specific discharge capacity (7B) as a function of surface coverage of PE particles on the anode, measured at 25° C. and at 110° C.

FIGS. 8A and 8B are graphs of specific charge capacity (8A) and of specific discharge capacity (8B) as a function of surface coverage of PE particles on the separator, measured at 25° C. and at 110° C.

FIG. 9 is a graph of specific charge capacity as a function of surface coverage of wax particles on the anode, measured at 25° C. and at 65° C.

FIG. 10 depicts SEM images of anode cross sections (FIG. 10A-10C) and anode surfaces (FIG. 10D-10F).

FIG. 11 depicts graphs of voltage as a function of specific cell capacity during charging and discharging.

FIG. 12 is a graph of specific charge capacity as a function of surface coverage of PE particles on the anode, measured at 25° C. and at 110° C. while cells were charging.

FIG. 13 depicts a SEM image of PE particles having dopamine immobilized on the particle surface.

FIGS. 14A and 14B depict optical micrographs of aqueous dispersions of neat PE particles (14A) and of PE particles with dopamine immobilized on the particle surface (14B).

FIGS. 15A and 15B depict SEM images of PE particles deposited on an anode surface, where the PE particles were neat (15A) or where the PE particles had surfaces modified with immobilized dopamine (15B).

FIGS. 16A and 16B are graphs of specific charge capacity as a function of surface coverage of neat PE particles and of hydrophilic PE particles on the anode, measured at 25° C. and at 110° C.

FIGS. 17A-17C depict SEM images of an anode having glass spheres and PE particles on its surface.

FIGS. 18A and 18B depict SEM images of an anode having glass spheres and PE particles on its surface.

FIGS. 19A and 19B depict SEM images of an anode having glass spheres and PE particles on its surface.

FIGS. 20A and 20B are graphs of voltage over time at 25° C. (20A) and at 110° C. (20B).

### DETAILED DESCRIPTION

In accordance with the present invention an autonomous battery shutdown system includes temperature-sensitive particles that respond to a thermal trigger by forming an ion barrier between the electrodes of a battery. The prevention of ion flow between the electrodes shuts down some or all of the battery, avoiding catastrophic failure of the battery. The thermally triggered system is believed to be applicable to, and customizable for, a wide variety of Li-ion battery chemistries and their unique shutdown requirements.

The autonomous battery shutdown system can be used to safely shut down a battery that has a performance level that is dangerous before catastrophic failure occurs. Such a “global shutdown” may be used to safely shut down a battery that is past the point of repair. The autonomous battery shutdown system also can be used to shut down an isolated area within a battery, while allowing future operation of other areas. Such a “local shutdown” may be used to extend the lifetime of a battery that would otherwise fail. Both types of shutdown may provide improvements in battery safety, a decrease in overall battery cost, and/or extended battery lifetimes.

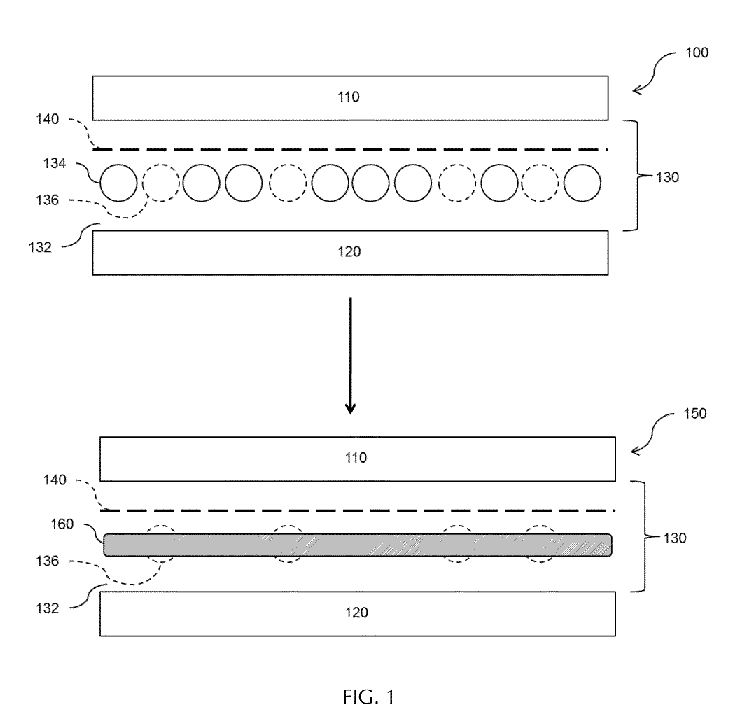

FIG. 1 is a schematic representation of an autonomous battery shutdown system that includes a battery 100 including an anode and a cathode (110 and 120), and an electrolyte composition 130 between the anode and the cathode. The electrolyte composition includes an ionically conductive liquid 132 containing lithium ions, and temperature-sensitive particles 134 including a polymer having a melting temperature between 60° C. and 120° C. The electrolyte composition optionally may include thermally stable particles 136. The system optionally may include a separator 140.

When the temperature of the battery 100 exceeds 120° C., the temperature-sensitive particles 134 form an ion barrier 160 that traverses the battery. Preferably the temperature-sensitive particles form an ion barrier 160 that traverses the battery when the temperature of the battery exceeds 115° C., or when the temperature of the battery exceeds 110° C. The resulting shutdown battery 150 may have a specific charge capacity that is more than 98% lower than the specific charge capacity of the original battery 100. In one example, the shutdown battery 150 may have a specific discharge capacity below 10 milliamp hours per gram (mA·h/g).

The anode and cathode (110 and 120) may be any anode or cathode that can be used for a rechargeable lithium ion battery, and the ionically conductive liquid 132 may be any liquid that can be used for a rechargeable lithium ion battery. Examples of anode materials for rechargeable lithium ion batteries include graphite (LiC₆), silicon, and titanate (Li₄Ti₅O₁₂), alkali metals, alkaline earth metals, Li—Al alloys, Li—Si alloys, and Li—B alloys. Examples of cathode materials for rechargeable lithium ion batteries include LiMn₂O₄, LiNi_{1/3}Mn_{1/3}Co_{1/3}O₂, LiCoO₂, LiNiO₂, and LiFePO₄, MnO₂, FeS₂, FeS, CuO, Bi₂O₃ and fluorocarbons. Examples of ionically conductive liquids for rechargeable lithium ion batteries include mixtures of one or more electrolyte salt such as LiPF₆, LiBF₄ or LiClO₄, with one or more organic solvents such as ethylene carbonate (EC), ethyl methyl carbonate (EMC), dimethyl carbonate (DMC) or diethyl carbonate (DEC).

The temperature-sensitive particles 134 may be solid particles, or they may be capsules. When the temperature of the battery exceeds 120° C., one or more components of the temperature-sensitive particles 134 form an ion barrier 160 that traverses the battery. Preferably one or more components of the temperature-sensitive particles melt and form an ion barrier 160 that traverses the battery when the temperature of the battery exceeds 115° C., or when the temperature of the battery exceeds 110° C. For temperature-sensitive particles 134 that are solid particles, at least one polymer in the particle melts when the temperature of the battery exceeds 120° C., 115° C. or 110° C., forming an ion barrier that traverses the battery. For temperature-sensitive particles 134 that are capsules, the capsule walls melt when the temperature of the battery exceeds 120° C., 115° C. or 110° C., and a barrier-forming substance is released from the capsules, forming an ion barrier that traverses the battery.

The temperature-sensitive particles 134 may have an aspect ratio of from 1:1 to 1:10, preferably from 1:1 to 1:5, more preferably from 1:1 to 1:3, more preferably from 1:1 to 1:2, and more preferably from 1:1 to 1:1.5. In one example, the temperature-sensitive particles may have an average diameter of from 10 nanometers (nm) to 1 millimeter (mm), more preferably from 30 to 500 micrometers, and more preferably from 50 to 300 micrometers. In another example, the temperature-sensitive particles may have an average diameter less than 10 micrometers.

The temperature-sensitive particles 134 may be solid particles that include one or more polymers, and optionally including one or more additives. Preferably solid temperature-sensitive particles 134 include at least one thermoplastic polymer having a melting temperature (T_{M}) between 60° C. and 120° C., between 80° C. and 115° C., or between 100° C. and 110° C. The melting temperature of the thermoplastic polymer and/or of an entire solid particle may be adjusted by including one or more additives in the particle. Examples of thermoplastic polymers having a melting temperature between 60° C. and 120° C. include polyethylene (typical T_{M} 100-110° C.), paraffin waxes (typical T_{M} 48-68° C.), beeswax (typical T_{M} 62-65° C.), microcrystalline wax (typical T_{M} 63-65° C.), candellila (typical T_{M} 67-70° C.), Polywax™ 500 (Petrolite Corp., typical T_{M} approximately 80° C.), rice bran wax (Frank B. Ross Corp, typical T_{M} approximately 81° C.), plant waxes such as Carnauba (typical T_{M} 82-86° C.), Epolene C-18 (Eastman, typical T_{M} 95-97° C.), Epolene E-14 (typical T_{M} approximately 100° C.), Petrolite Bareco hard microcrystalline C700 (Petrolite Corp., typical T_{M} approximately 81° C.) and low density poly(vinyl chloride) (typical T_{M} approximately 100° C.).

The temperature-sensitive particles 134 may be capsules having a capsule wall enclosing an interior volume, where the interior volume includes a barrier-forming agent. The capsule wall preferably has a melting temperature between 60° C. and 120° C., and may include at least one thermoplastic polymer and optionally may include one or more additives, as described above. The barrier-forming agent may be, for example, a polymerizer or an activator for a polymerizer. In one example, the barrier-forming agent includes a polymerizer such as divinyl benzene, which can polymerize to form poly(divinyl benzene) when contacted with the ionically conductive liquid 132. In another example, the ionically conductive liquid 132 may include a polymerizer, and the barrier-forming substance may include an activator for the polymerizer, such as an activator for the polymerization of carbonates. Examples of polymerizers that may be included in the capsules include divinyl benzene, 3-alkylthiophene, and a thermally polymerizable acrylate (i.e. Photomer 4028). Examples of activators that may be included in the capsules include dialkylzinc; radical sources such as AIBN and benzoyl peroxide and its derivatives; Lewis acids and bases such as potassium hydrogen carbonate, methyl triflate and triethyloxonium fluoroborate; and protic compounds such as alcohols, amines and thiols. The capsules may contain other ingredients in addition to the barrier-forming agent.

Capsules having an average outer diameter less than 10 micrometers, and methods for making these capsules, are disclosed, for example, in U.S. Patent Application Publication No. 2008/0299391 A1 to White et al., published Dec. 4, 2008. The thickness of the capsule wall may be, for example, from 30 nm to 10 micrometers. For capsules having an average diameter less than 10 micrometers, the thickness of the capsule wall may be from 30 nm to 150 nm, or from 50 nm to 90 nm. The selection of capsule wall thickness may depend on a variety of parameters, such as the nature of the ionically conductive liquid 132, and the conditions for making and using the battery 100. For example, a capsule wall that is too thick may not melt rapidly enough to release the barrier-forming agent when the temperature of the battery exceeds 120° C., while a capsules wall that is too thin may break manufacture or normal use of the battery.

Capsules may be made by a variety of techniques, and from a variety of materials. Examples of materials from which the capsules may be made, and the techniques for making them include: polyurethane, formed by the reaction of isocyanates with a diol; urea-formaldehyde (UF), formed by in situ polymerization; gelatin, formed by complex coacervation; polyurea, formed by the reaction of isocyanates with a diamine or a triamine, depending on the degree of crosslinking and brittleness desired; polystyrene or polydivinylbenzene formed by addition polymerization; and polyamide, formed by the use of a suitable acid chloride and a water soluble triamine. For capsules having an average diameter less than 10 micrometers, the capsule formation may include forming a microemulsion containing the capsule starting materials, and forming microcapsules from this microemulsion.

The temperature-sensitive particles 134 optionally may have a hydrophilic surface. A hydrophilic surface may provide for a more even dispersion of the temperature-sensitive particles 134 in an aqueous liquid that would be possible if the particles had a hydrophobic surface. As a result, temperature-sensitive particles 134 having a hydrophilic surface may be more evenly distributed on the surface of an electrode (110 or 120) and/or on the optional separator 140. A more even distribution of the temperature-sensitive particles 134 is believed to provide a more even formation of the ion barrier 160 at temperatures above 120° C.

In one example of a hydrophilic surface, the temperature-sensitive particles 134 may include a hydrophilic substance immobilized on the particle surface. A substance may be immobilized due to chemical bonding with the surface and/or due to adsorption on the surface, and the immobilization may be permanent or temporary, and may be dependent on the surrounding environment. An example of a hydrophilic substance is dopamine, which may be immobilized on the surfaces of PE or wax particles by contacting the particles with a liquid mixture of dopamine in methanol having a basic pH. In another example of a hydrophilic surface, the temperature-sensitive particles 134 may be subjected to a surface treatment to form hydrophilic surface on the particles. An example of a hydrophilic surface treatment is a corona discharge.

The optional thermally stable particles 136 may include any non-conductive material that does not soften or melt at temperatures below 120° C. Examples of materials that may be present in thermally stable particles 136 include polymers and ceramics. Polymeric materials such as a polyester, a polycarbonate, a polyamide, an epoxy polymer, an aramid polymer or combinations of these polymers may have glass transition temperatures above 120° C., and thus will not soften at temperatures below 120° C. Such polymeric materials also may have melt temperatures above 120° C., and thus will not melt at temperatures below 120° C. Ceramic materials such as a glass, a silica or a zeolite may have melting and/or degradation temperatures above 120° C., and thus will not soften or melt at temperatures below 120° C. Optional thermally stable particles 136 may be solid, or they may be capsules having a capsule wall enclosing an interior volume.

Optional thermally stable particles 136 may play one or more roles in the battery 100. The optional thermally stable particles 136 may provide spacing between the anode 110 and cathode 120, effectively replacing the separator conventionally present in a battery. The optional thermally stable particles 136 may provide a scaffold for the ion barrier formed from the temperature-sensitive particles 134, and may allow for a more rapid shutdown response. The properties of the thermally stable particles 136, and their surface coverage on an electrode, may be varied in order to optimize the performance and/or the shutdown response of the battery 100.

If present, the optional thermally stable particles 136 may have a surface coverage that is equal to, less than or greater than the surface coverage of the temperature-sensitive particles 134. If present, the optional thermally stable particles 136 may have a size and shape similar to that of the temperature-sensitive particles 134, or the two types of particles may have size and/or shapes that are different. Optional thermally stable particles 136 may have an aspect ratio of from 1:1 to 1:10, preferably from 1:1 to 1:5, more preferably from 1:1 to 1:3, more preferably from 1:1 to 1:2, and more preferably from 1:1 to 1:1.5. Optional thermally stable particles 136 may have an average diameter of from 10 nanometers (nm) to 1 millimeter (mm), more preferably from 20 to 500 micrometers, and more preferably from 25 to 300 micrometers. In another example, optional thermally stable particles may have an average diameter less than 10 micrometers.

The temperature-sensitive particles 134 may be in contact with one or both of the anode and cathode (110 and 120). If a separator 140 is present, the temperature-sensitive particles 134 may be in contact with the separator, or there may be a distance between the particles and the separator. Examples of materials for the optional separator 140 include monolayers of polypropylene (PP) or polyethylene (PE), and trilayers of PP and PE, such as (PP/PE/PP) or (PP/PE/PP). Within these categories, variations within these categories include different thicknesses and porosities.

The ion barrier 160 may be any material that hinders the flow of ions between the anode and the cathode (110 and 120). In one example, the ion barrier 160 includes a polymer film, such as a polymer film formed from temperature-sensitive particles 134 that had melted at a temperature above 120° C., or a polymer film formed from a barrier-forming material that had been released from the temperature-sensitive particles at a temperature above 120° C. In another example, the ion barrier 160 includes a crosslinked polymer formed by a reaction between the barrier-forming material and one or more ingredients of the ionically conductive liquid 132.

Due to the presence of the ion barrier 160, the shutdown battery 150 has an initial specific discharge capacity that is 10% or less of the specific discharge capacity of the battery 100, which does not include the ion barrier. Preferably the shutdown battery 150 has an initial specific discharge capacity that is 5% or less of the specific discharge capacity of the battery 100, preferably 2% or less of the specific discharge capacity of the battery 100, and preferably 1% or less of the specific discharge capacity of the battery 100.

The following examples are provided to illustrate one or more preferred embodiments of the invention. Numerous variations can be made to the following examples that lie within the scope of the invention.

### EXAMPLES

### Materials and Equipment

Low density poly(ethylene) (PE; M_{w}=4000, mp 110° C.), Brij® 76 surfactant, sodium dodecyl sulfate (SDS), paraffin wax (mp 58-60° C.) and N-methylpyrrolidone (NMP) were purchased from Sigma-Aldrich. Xylene was purchased from Fisher Scientific. Poly(vinylidene fluoride) (PVDF) binder was purchased from Alfa Aesar. Bulk mesocarbon microbead (MCMB) anode material (Enerland), Li(Ni_{1/3}Co_{1/3}Mn_{1/3})O₂(Li333) cathode material (Enerland), Celgard® 2325 separator material, and 1.2 M LiPF₆ in EC:EMC electrolyte were obtained from Argonne National Laboratory. Anodes were cut to the appropriate size using a 1.27 cm punch purchased from McMaster-Carr. Functionalized anodes were prepared using a Specialty Coating Systems spin-coater. C2032-type coin cell hardware components and the coin cell crimper were purchased from MTI Corporation, with the exception of coin cell springs, which were purchased from Hohsen/Pred Materials Corp. The thermal testing apparatus includes 50 cP silicone oil (Sigma-Aldrich), hose clamps, and electrical leads. All coin cells were cycled using an Arbin BT2000 cycler.

### Example 1

### Formation of Polyethylene Temperature-Sensitive Particles

Polyethylene (PE) particles were prepared by a solvent evaporation technique. PE (8 g) was dissolved in 55 mL of xylenes at 75° C. The PE/xylene mixture was added to 150 mL of an aqueous surfactant mixture containing 1 wt % Brij® 76 (75 mL) and 1 wt % sodium dodecyl sulfate (SDS; 75 mL). The PE mixture was heated to 90° C. and mechanically stirred at 1,000 revolutions per minute (rpm). The xylene was allowed to evaporate for 30 min under continuous agitation, at which point an additional 90 mL of the Brij/SDS surfactant mixture was added to the PE mixture. After an additional 30 min, stirring was stopped and the reaction beaker was removed from the heated bath. PE particles were gravimetrically separated from the liquid mixture, decanted, centrifuged and rinsed three times with deionized water to remove excess surfactant.

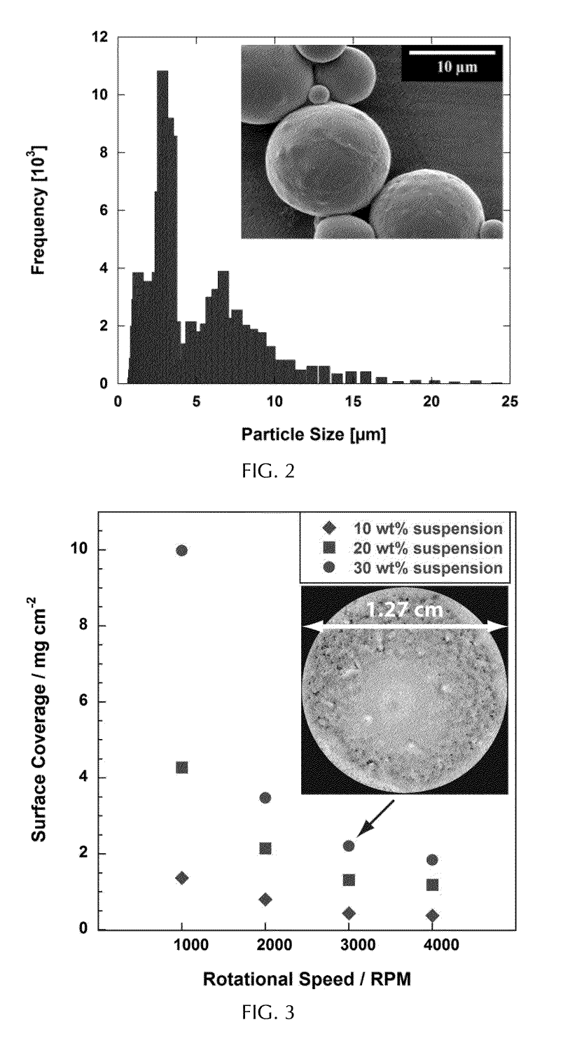

FIG. 2 is a histogram of the measured diameters of the PE particles. The diameters had a bimodal distribution with a number average diameter of 4 micrometers and a weight average diameter of 9 micrometers. The inset of FIG. 2 depicts a scanning electron microscopy (SEM) image of the PE particles. The exterior surface appeared to be smooth by SEM. The melting point of the PE particles as determined by differential scanning calorimetry (DSC) was 105° C.

### Example 2

### Formation of Paraffin Wax Temperature-Sensitive Particles

Paraffin wax particles were prepared by a meltable dispersion technique. Paraffin wax (20 g) was melted at 65° C. and added to 175 mL of an aqueous surfactant mixture of 1% poly(vinyl alcohol) (25 mL) and deionized water (150 mL). The wax/water mixture was heated to 70° C. and mechanically stirred at 2,000 rpm to form an emulsion. After 2 minutes of stirring, deionized ice water (500 mL at 0° C.) was added to the emulsion to solidify the wax particles. After this solidification, the wax particles were rinsed to remove excess surfactant, and then air dried.

The diameters of the wax particles had a bimodal distribution with a number average diameter of 42 micrometers and a weight average diameter of 47 micrometers. The exterior surface appeared to be rough by SEM.

### Example 3

### Preparation of PE Particle-Coated Electrode

Anodes coated with PE temperature-sensitive particles were prepared by spin-coating a suspension of the PE particles of Example 1 onto graphitic anode disks (1.27 cm diameter). A particle suspension was prepared by combining the particles with a poly(vinylidene fluoride) binder in a 10:1 ratio, and then adding varying amounts of N-methylpyrrolidone (NMP) solvent. The suspension was manually stirred to ensure a homogenous dispersion of the binder. Using a 1 mL syringe (Beckton-Dickinson) outfitted with an 18 gauge needle, 0.075 mL of the suspension was deposited onto a spinning anode disk. The surface coverage of PE particles on each anode was controlled by adjusting the concentration of PE particles in the suspension and the rotation speed of the spin coater. Once coated, anodes were removed from the spin-coater stage and dried for a minimum of 24 h before incorporation into coin cells.

Surface coverages of the PE particles on the anodes were determined gravimetrically, by weighing the coated anode after drying and dividing the added mass by the anode disk surface area. Surface coverage (ρ) of the particles on the anode was defined as ρ=m_{particle}/SA_{substrate}, where m_{particle} is the mass of particles functionalized onto the substrate and SA_{substrate} is the surface area of the substrate.

FIG. 3 is a graph of electrode surface coverage as a function of spin coating rotational speed for PE particle suspensions having various particle concentrations. Higher surface coverage was obtained by increasing the concentration of particles in suspension or by reducing the spin rate. The inset of FIG. 3 depicts optical micrographs of anode surfaces after spin coating with PE particle suspensions at 3,000 rpm. During the spinning process, particles tended to accumulate near the edge of the anode, and some aggregation of microspheres was evident during the drying process. Profilometry of an anode with ρ=5.5 mg cm⁻² gave an RMS roughness of 5.9 micrometers, compared to an RMS roughness of 1.5 micrometers for a control anode (ρ=0 mg cm⁻²).

### Example 4

### Preparation of Wax Particle-Coated Electrode

Anodes coated with paraffin wax temperature-sensitive particles were prepared by spin-coating a suspension of the paraffin wax particles of Example 2 onto graphitic anode disks (1.27 cm diameter). A particle suspension was prepared by combining the particles with a poly(vinylidene fluoride) binder in a 10:1 ratio, and then adding varying amounts of N-methylpyrrolidone (NMP) solvent. The suspension was manually stirred to ensure a homogenous dispersion of the binder. Using a 1 mL syringe (Beckton-Dickinson) outfitted with an 18 gauge needle, 0.075 mL of the suspension was deposited onto a spinning anode disk. The surface coverage of wax particles on each anode was controlled by adjusting the concentration of wax particles in the suspension and the rotation speed of the spin coater. Once coated, anodes were removed from the spin-coater stage and dried for a minimum of 24 h before incorporation into coin cells.

Surface coverages of the wax particles on the anodes were determined gravimetrically, by weighing the coated anode after drying and dividing the added mass by the anode disk surface area. Higher surface coverage was obtained by increasing the concentration of particles in suspension or by reducing the spin rate.

### Example 5

### Preparation of PE Particle-Coated Separator

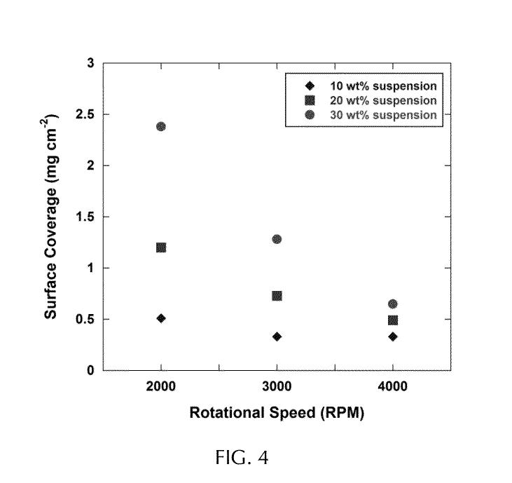

Separators coated with PE temperature-sensitive particles were prepared according to the procedure of Example 4, using a commercially available separator material instead of an electrode. The separators were trilayer PP-PE-PP separator disks (Celgard® 2325) having diameters of 1.75 cm. FIG. 4 is a graph of separator surface coverage as a function of spin coating rotational speed for PE particle suspensions having various particle concentrations. As in Example 4, higher surface coverage was obtained by increasing the concentration of particles in suspension or by reducing the spin rate. In some examples, higher surface coverage was obtained by depositing the particle suspension without spin-coating and allowing the coated separator to air dry.

### Example 6

### Assembly and Testing of Li-Ion Coin Cells

Anodes or separators coated with PE temperature-sensitive particles were assembled into coin cells in an argon-filled glove box. The stacking sequence of the coin cell was the anode cap, spring, spacer, anode disk, Celgard® 2325 separator, 6 drops of 1.2 M LiPF₆ in ethylene carbonate:ethyl methyl carbonate (EC:EMC; ratio of 3:7) electrolyte, cathode disk (Li(Ni_{1/3}Co_{1/3}Mn_{1/3})O₂(Li333)), spacer, and top cap.

After assembly, cells were removed from the glove box and mounted in the cycler test channels. The cells were cycled three times at room temperature (25° C.). The first cycle consisted of a constant charge at a current of +1.75 mA from 1 V to 4.2 V, followed by a discharge at a current of −1.75 mA from 4.2 V to 3 V. The remaining two cycles each consisted of a constant charge at a current of +1.75 mA from 3 V to 4.2 V, followed by a discharge at a current of −1.75 mA from 4.2 V to 3 V. The window of 3-4.2 V was selected based on the cathode material.

For thermal testing, the cycling program commenced as soon as the cell was fully submerged in oil having a temperature of 110° C. One cycle consisted of a constant charge at a current of +1.75 mA from 3 V to 4.2 V, followed by a discharge at a current of −1.75 mA from 4.2 V to 3 V. The cell was allowed to cycle until it completed 3 full cycles. Voltage after the third cycle was briefly monitored to make sure that the cell did not short circuit, but rather shut down. The cell was then removed from the oil, allowed to cool, and removed from the thermal testing clamp.

### Example 7

### Analysis of Cell Capacity Loss for Cells Having Only Conventional Shutdown Separator

Control experiments were conducted to investigate the shutdown profile of a commercially available CR2032 coin-cell type Li-ion battery containing a commercial tri-layer PP/PE/PP Celgard® 2325 shutdown separator. As no PE temperature-sensitive particles were present, ρ=0. Cells were first cycled at the 1 C rate from 3 V to 4.2 V at room temperature (25° C.) to verify cell operation. Voltage and current were monitored with time. Room temperature cycling was followed by thermal testing at 135° C., the softening temperature of the PE layer in the PP-PE-PP separator and activation temperature of the shutdown separator. Temperature was maintained by submerging the cell in 1 L of silicone oil heated to 135° C. The cell was tested by cycling at the 1 C rate from 3 V to 4.2 V.

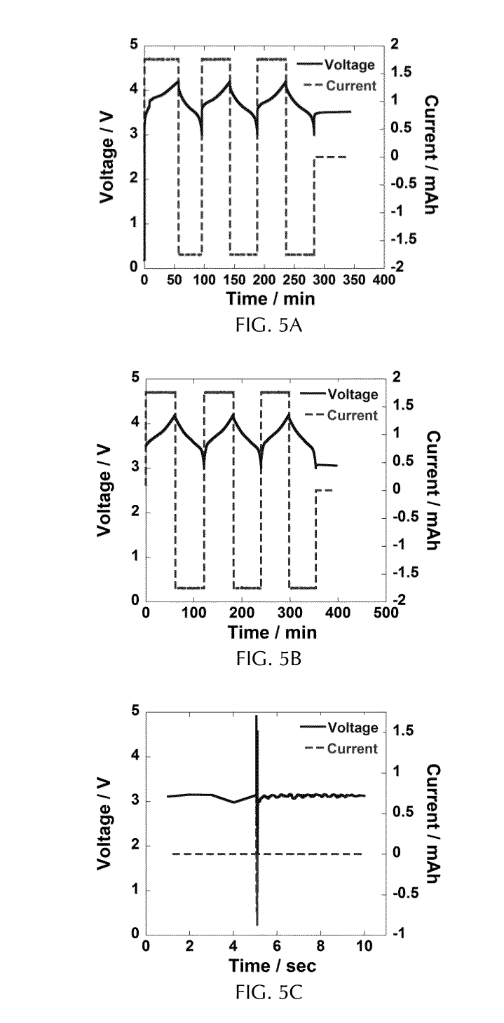

FIG. 5A is a graph of voltage and current over time at room temperature, FIG. 5B is a graph of voltage and current over time for the same cell after thermal testing at 110° C., and FIG. 5C is a graph of voltage and current over time for the same cell after thermal testing at 135° C. When the cell was cycled at 135° C., cell shutdown occurred, and the area under a current vs. time plot was zero indicating that no charge had been transferred. No decrease in capacity (indicating shutdown) was observed for temperatures less than 135° C. Post-cycling analysis of the commercial cell revealed that the separator was deformed as a result of shutdown activation, risking a short circuit.

### Example 8

### Analysis of Cell Capacity Loss for Cells Having PE Temperature-Sensitive Particles and a Conventional Shutdown Separator

Experiments were conducted according to the method of Example 7 to investigate the shutdown profile of a CR2032 coin-cell type Li-ion battery containing both PE temperature-sensitive particles and the commercial tri-layer PP/PE/PP Celgard® 2325 shutdown separator. The PE particles were present at a coverage of ρ=12.7 mg cm⁻². The cells containing PE particles were first cycled at the 1 C rate from 3 V to 4.2 V at 25° C. to verify cell operation, and voltage and current were monitored with time. Room temperature cycling was followed by thermal testing at 110° C., the softening temperature of the PE particles. Temperature was maintained by submerging the cell in 1 L of silicone oil heated to 110° C. The cell was tested by cycling at the 1 C rate from 3 V to 4.2 V.

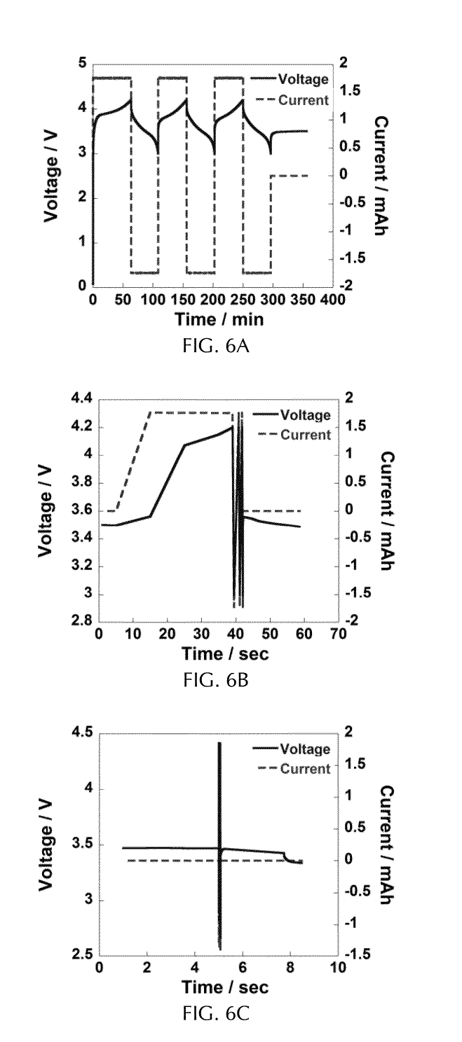

FIG. 6A is a graph of voltage and current over time at room temperature, FIG. 6B is a graph of voltage and current over time for the same cell after thermal testing at 110° C., and FIG. 6C is a graph of voltage and current over time at 135° C. for the cell after being shut down at 110° C. At room temperature, the cells containing PE particles demonstrated a voltage and current profile (FIG. 6A) similar to that of the cells of Example 7, which contained only the commercial shutdown separator and no PE particles (FIG. 5A). At 110° C., cell shutdown was activated due to the melting of the PE particles (FIG. 6B). Once a cell containing PE particles was shutdown, further heating to 135° C. (the activation temperature of the commercial shutdown separator) did not change the voltage or current profile of the cell (FIG. C). These results indicate that the cell was already shut down after being held at 110° C.

Thus, graphitic anodes and commercial trilayer shutdown separators were combined with PE particles to form an autonomic battery shutdown system. Autonomic shutdown of a coin cell Li-ion battery cell was achieved using an experimental protocol based on uniformly heating the cell to simulate overheating conditions. A critical PE particle surface coverage, ρ>7.0 mg cm⁻² was observed to perform complete shutdown (loss of >98% of the initial cell capacity). Post-shutdown analysis of an anode revealed evidence of newly formed, ion-insulating PE film.

### Example 9

### Effect of Temperature-Sensitive PE Particle Coverage on Shutdown Performance During Charging and Discharging

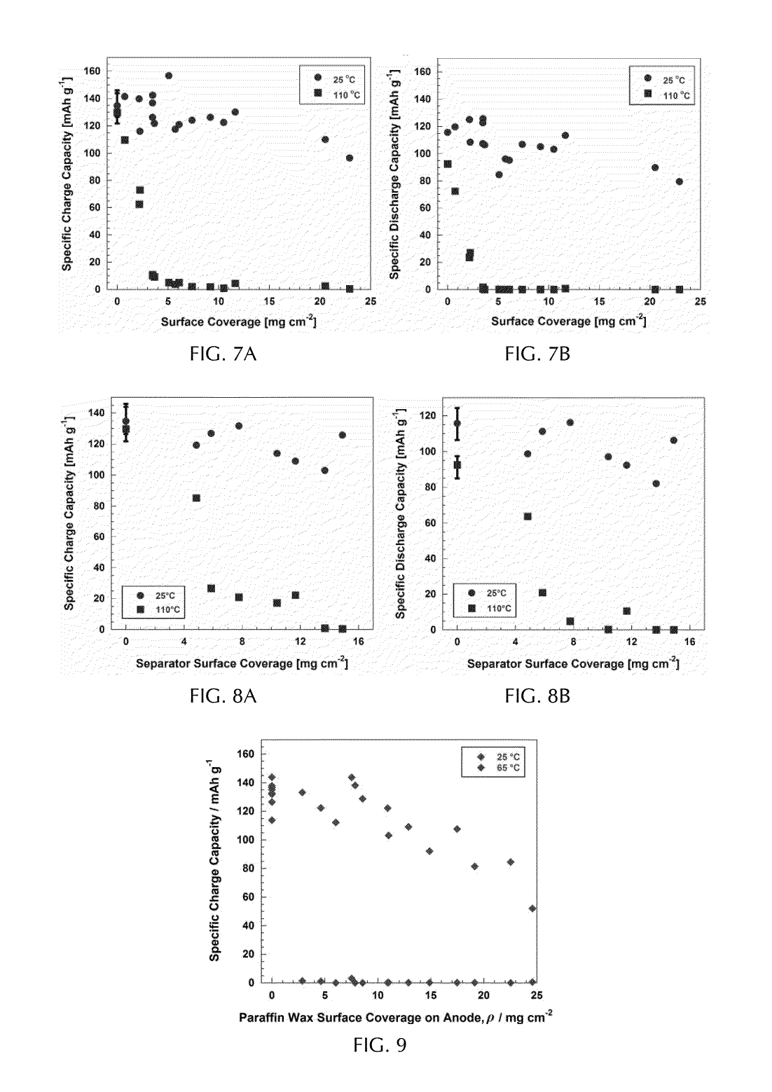

To evaluate the effect of temperature-sensitive particle loading on shutdown performance, anodes or separators with varying particle surface coverage were prepared, incorporated into coin cells, and tested during charging and discharging using the method of Example 8. Specific charge and discharge capacity was used as a metric for shutdown performance. FIGS. 7A and 7B are graphs of specific charge capacity (7A) and of specific discharge capacity (7B) as a function of surface coverage of PE particles on the anode, measured at 25° C. and at 110° C. FIGS. 8A and 8B are graphs of specific charge capacity (8A) and of specific discharge capacity (8B) as a function of surface coverage of PE particles on the separator, measured at 25° C. and at 110° C. while cells were charging. The results observed during charging (FIGS. 7A and 8A) were similar to those observed during discharging (FIGS. 7B and 8B).

In cells where PE particles were coated on the anode, the initial charge capacity measured at 25° C. did not significantly decrease until ρ=20 mg cm⁻² (FIG. 7A). In cells where PE particles were coated on the separator, fluctuations in specific capacity (25° C.) were observed for the coverages tested (FIG. 8A). For low PE particle coverage on the anode, i.e., ρ=2.0 mg cm⁻², a partial decrease in specific charge and discharge capacity as a result of thermal treatment (110° C.) was observed. At ρ=3.5 mg cm⁻², the specific charge and discharge capacity was significantly decreased at 110° C., though the cell retained a small percentage of its initial capacity. The critical coverage for full shutdown with PE-functionalized separators was to be ρ=13.7 mg cm⁻², a value higher than for cells in which the PE particles were applied to the anode, or for cells in which paraffin wax particles were applied to the anode (see Example 10).

From the coverages tested, the minimum observed coverage required for full cell shut down (loss of >98% initial capacity) was 7.4 mg cm⁻². At this coverage, shutdown occurred within approximately 6 min. In comparison, the time scale in which thermal runaway as a result of a short circuit occurs is reported to be approximately 1 min (J. W. Evans, with Yufei Chen and Li Song, in IECEC 96. Proceedings of the 31st Intersociety Energy Conversion Engineering Conference, 11-16 Aug. 1996, IEEE, New York, N.Y., USA 1996, 1465-70). Coverage of 9.2 mg cm⁻², 10.5 mg cm⁻², and 20.5 mg cm⁻² induced shutdown in 2.5 min, 65 s, and 37 s, respectively.

### Example 10

### Effect of Temperature-Sensitive Wax Particle Coverage on Shutdown Performance During Charging

To demonstrate that the microsphere-based autonomic shutdown concept is not limited to PE microspheres alone, paraffin wax particles of Example 2 (melting point=60° C.) were incorporated into Li-ion coin cell batteries and tested at room temperature and at 65° C. using the method of Example 9. FIG. 9 is a graph of specific charge capacity as a function of surface coverage of wax particles on the anode, measured at 25° C. and at 65° C.

As observed with the cells containing PE-coated anodes, cell shutdown was achieved above a certain critical coverage (ρ=2.9 mg cm⁻²). Shutdown using paraffin wax microspheres occurred rapidly at coverages of 7.5, 8.6, and 21.0 mg cm⁻², resulting in shutdown in 244, 22, and 5.2 seconds, respectively. Room temperature capacity of coin cells was unaffected until ρ=7.6 mg cm⁻² when cycling at 1 C.

### Example 11

### Thermal Behavior of PE-Coated Anodes

To maintain cycle life and ensure safe operation, temperatures of Li-ion batteries should be kept below 45° C. For this reason, thermal stability of the PE temperature-sensitive particle coating was investigated at the upper temperature of the safe operating range, 45° C., and compared to cell performance at room temperature (25° C.). A coin cell with ρ=6.6 mg cm⁻² (i.e., above the critical surface coverage for shutdown at 110° C.) was thermally tested at 45° C. At 25° C. and 45° C., the specific charge capacities (averaged over 3 cycles) are 122 g⁻¹ and 120 mA·h/g, respectively, indicating no significant loss in capacity as a result of heating. At 45° C., the particles are well below the softening point (70° C.) and melting point of PE (105° C.), as determined by DSC. As the temperature increased beyond 105° C., cell shutdown commenced.

### Example 12

### Electrode Morphology after Shutdown

To verify cell shutdown, impedance tests were performed on coin cells at various (low, medium, and high) coverages. Coins cells were assembled with various coverages of PE microspheres and tested as described above prior to impedance testing. Impedance testing was performed in a frequency range of 0.05 Hz to 100 kHz using both a CH Instruments Model 660 Electrochemical Workstation and a Schlumberger SI 1260 Impedance/Gain-Phase analyzer.

Table 1 lists the results of impedance testing for the cells. Cell impedance increased by several orders of magnitude as a result of polymer film formation during shutdown. For example, at approximately 9 mg cm² coverage, the cell impedance increased by roughly two orders of magnitude from 25° C. to 110° C. There was also a significant increase in post-shutdown impedance for cells above the critical coverage concentration (ρ=2.9 mg cm²) in comparison to control cells (ρ=0 mg cm²).

TABLE 1
Impedance data at 1 kHz for coin cells cycled
at 25° C. and 110° C.

Impedance (Ω; 1 kHz)

| Coverage (ρ; mg cm⁻²) | 25° C. | 110° C. |
|---|---|---|
| None (0) | 8.14 | 368 |
| Low (1.8-2.2) | 8.88 | 342 |
| Medium (8.9-9.2) | 9.75 | 1,010 |
| High (16.7-18.1) | 18.8 | 10,500 |

### Example 13

### Electrode Morphology after Shutdown

Post-shutdown cells were disassembled and the anode, separator, and cathode were isolated from the battery hardware and allowed to dry. Once dry, the anode, separator, and cathode were examined by SEM. For cells where full shutdown occurs, some of the molten PE was observed on the anode surface, while some had infiltrated the rough, porous anode.

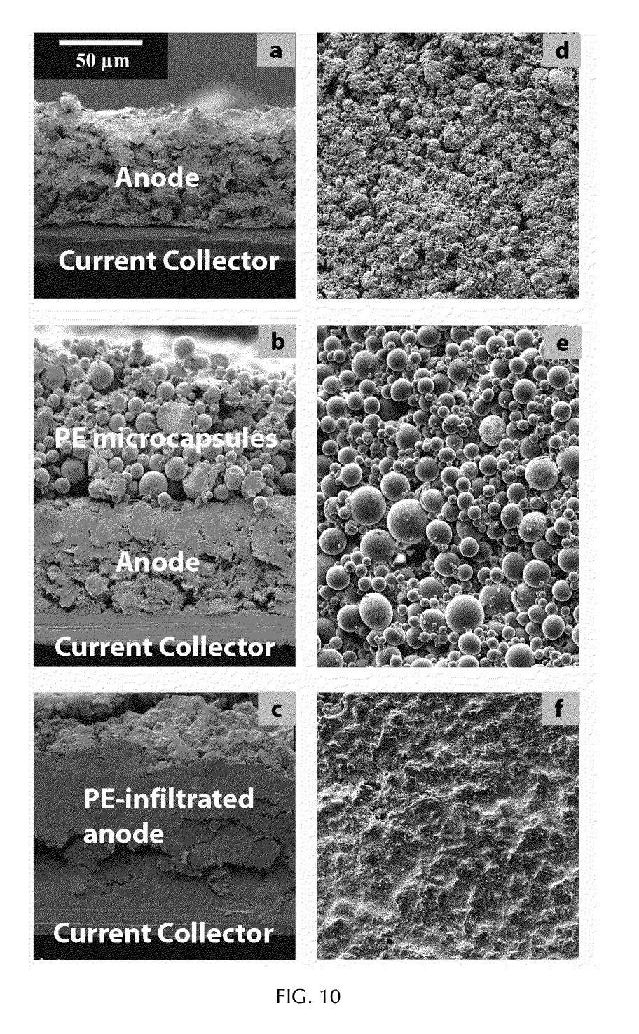

FIG. 10 depicts SEM images of anode cross sections (FIG. 10A through 10C) and anode surfaces (FIG. 10D through 10F). FIG. 10A depicts an SEM image of a cross-sectional view of a cycled and heated (110° C.) anode. FIG. 10B depicts an SEM image of a cross-sectional view of an unheated anode with ρ=7.7 mg cm⁻². FIG. 10C depicts an SEM image of a cross-sectional view of a cycled, heated anode with ρ=7.7 mg cm⁻². FIG. 10D depicts an SEM image of a surface view of a cycled and heated (110° C.) anode. FIG. 10E depicts an SEM image of a surface view of an unheated anode with ρ=7.7 mg cm⁻². FIG. 10F depicts an SEM image of a surface view of a cycled, heated anode with ρ=7.7 mg cm⁻².

### Example 14

### Long Term Cycling Performance

To investigate the effect of PE temperature-sensitive particles on coin cell performance, cells were cycled at room temperature (25° C.) at a rate of C/5. The surface coverage chosen for this experiment (7.5 mg cm⁻²), was above the critical coverage required for shutdown. The control cells, which did not contain particles, were also cycled at room temperature and at a rate of C/5.

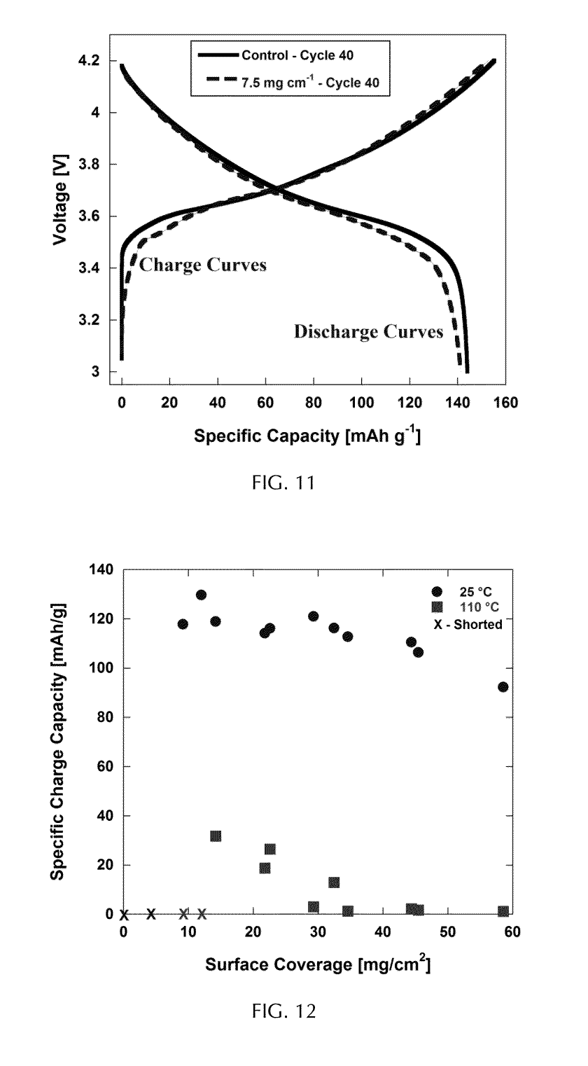

FIG. 11 depicts graphs of voltage as a function of specific cell capacity during charging and discharging. For a given control and PE particle-containing cell tested over 40 cycles, the percent difference in specific charge capacity from cycle 2 to cycle 41 for the control cell and PE particle-containing cell were +0.15% and −3.2%, respectively. The associated percent difference in specific discharge capacity from cycle 2 to cycle 41 for the control cell and PE particle-containing cell were +0.61% and −2.5% respectively. The presence of the particles slightly decreased coin cell performance over 40 cycles, relative to the control. The long term studies of coin cells containing PE particles indicated that that charge and discharge capacity were minimally affected by the presence of the particles.

### Example 15

### Assembly and Testing of Cell without Separator

Anodes coated with PE temperature-sensitive particles were prepared according to Example 3, and were used to assemble coin cells according to Example 6. The cells were tested according to Example 6. Specific charge capacity was used as the metric for shutdown performance, as described in Example 9.

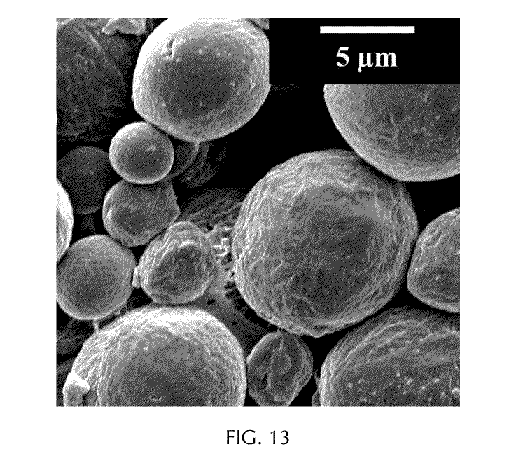

FIG. 12 is a graph of specific charge capacity as a function of surface coverage of PE particles on the anode, measured at 25° C. and at 110° C. while cells were charging. The two “x” designations at the left indicate that the cells did not cycle successfully at room temperature, and the two “x” designations at the right indicate that the cells cycled successfully at room temperature, but then shorted when heated.

The PE particles served both as a physical barrier to prevent shorting and as a shutdown mechanism once the particles are triggered at 110° C., the melting point of the PE. At lower surface coverage, the cells were not able to cycle, even at room temperature, due to shorting.

### Example 16

### Formation of Temperature-Sensitive PE Particles Having Hydrophilic Surface, and Preparation of Hydrophilic PE Particle-Coated Electrode

Dopamine was immobilized on the surface of polyethylene particles according to the method of M. H. Ryou et al., Advanced Materials, 23 (2011), 3066-3070. Polyethylene temperature-sensitive particles prepared according to Example 1 were added to a liquid mixture containing dopamine, methanol, and a buffer, where the liquid mixture had a pH of 8.5. The particles were then removed from the liquid, rinsed and dried to provide PE particles having a hydrophilic surface. FIG. 13 depicts a SEM image of the resulting PE particles having dopamine immobilized on the particle surface.

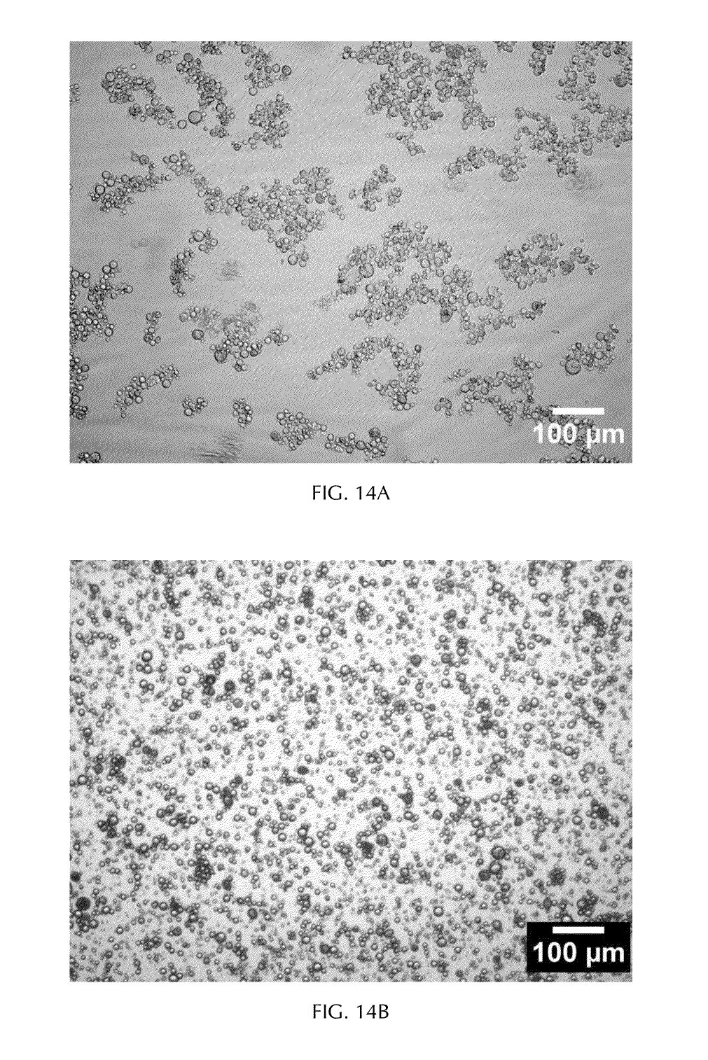

The PE particles having a hydrophilic surface could be dispersed in an aqueous liquid, and the resulting dispersion had less agglomeration of particles than a comparable dispersion of the PE particles of Example 1. FIG. 14A depicts an optical micrographs of a dispersion of neat PE particles in a mixture of water and Tween 20 surfactant. FIG. 14B depicts an optical micrograph of a dispersion of the PE particles with dopamine immobilized on the particle surface in a mixture of water and Tween 20 surfactant. The dispersion of the PE particles having a hydrophilic surface (14B) had much less particle agglomeration than did the dispersion of the neat PE particles (14A).

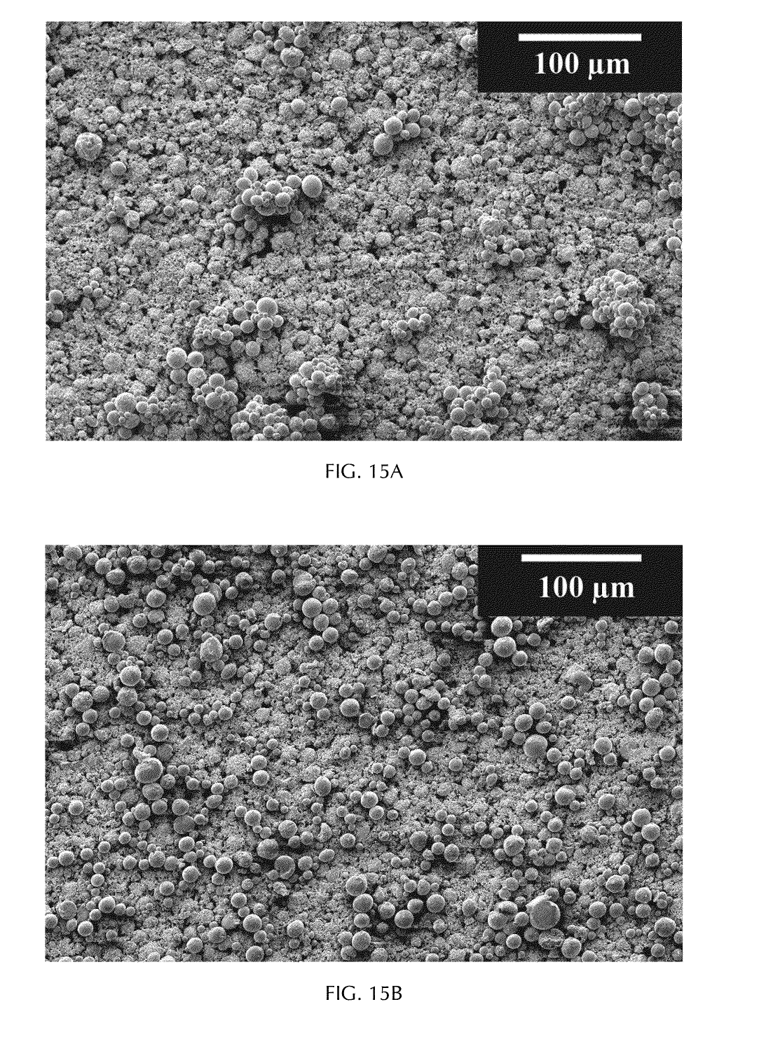

Dispersions of the PE particles of Example 1 and of the PE particles having dopamine immobilized on the particle surface were deposited on anode surfaces. The neat PE particles of Example 1 were dispersed in a mixture of NMP solvent and poly(vinylidene fluoride) binder. The PE particles with dopamine immobilized on the particle surface were dispersed in a mixture of water, 0.5 wt % carboxymethyl cellulose binder, and 2.5 wt % Tween 20 surfactant. Each dispersion was used separately to deposit particles on an anode according to Example 3. FIGS. 15A and 15B depict SEM images of PE particles deposited on an anode surface, where the PE particles were neat (15A) or where the PE particles had surfaces modified with immobilized dopamine (15B). The PE particles having a hydrophilic surface (15B) were distributed much more evenly on the anode surface than were the neat PE particles (15A).

### Example 17

### Effect of Temperature-Sensitive PE Particle Distribution on Shutdown Performance During Charging and Discharging

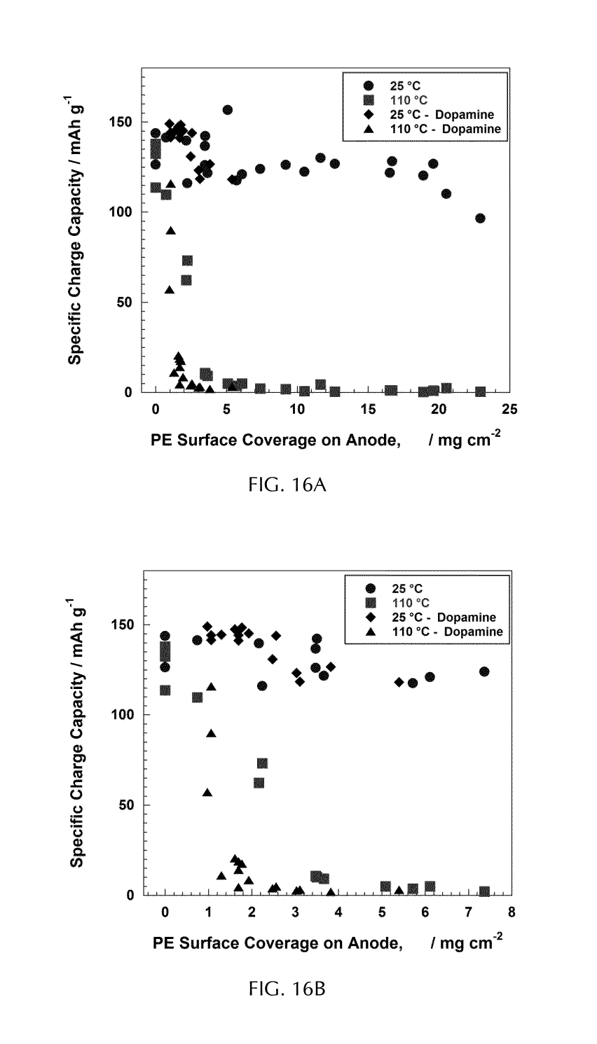

To evaluate the effect of temperature-sensitive particle distribution on shutdown performance, anodes with varying particle surface coverage were prepared. The anodes were incorporated into coin cells and tested during charging and discharging using the method of Example 9. Specific charge capacity was used as a metric for shutdown performance. FIG. 16A is a graph of specific charge capacity as a function of surface coverage of neat PE particles and of hydrophilic PE particles on the anode, measured at 25° C. and at 110° C. FIG. 16B is a detail of the graph of FIG. 16A, limited to surface coverages of ρ=0-8 mg cm⁻².

The charge capacity measured at 25° C. did not appear to be affected by whether the PE particles were neat or contained immobilized dopamine. During thermal treatment at 110° C., however, the cells containing PE particles having dopamine immobilized on the surface exhibited shutdown at particle coverages lower than those required for the cells containing neat PE particles.

### Example 18

### Preparation of Electrodes Coated with Temperature-Sensitive Particles and with Thermally Stable Particles

A first set of anodes coated with PE temperature-sensitive particles and thermally stable particles was prepared by depositing a suspension containing glass spheres and containing PE particles onto graphitic anode disks (1.27 cm diameter). A particle suspension was prepared by combining water, 0.2 grams of glass spheres having an average diameter of 25 micrometers, 0.1 grams of PE particles having a hydrophilic surface of Example 16, 0.5 wt % carboxymethyl cellulose, and 2.5 wt % Tween 20 surfactant. The suspension was stirred to ensure a homogenous dispersion of the binder. A portion of the suspension was deposited onto an anode disk, and the thickness of the suspension on the anode surface was reduced by passing a doctor blade over the surface. The height of the doctor blade above the anode surface was approximately 76 micrometers.

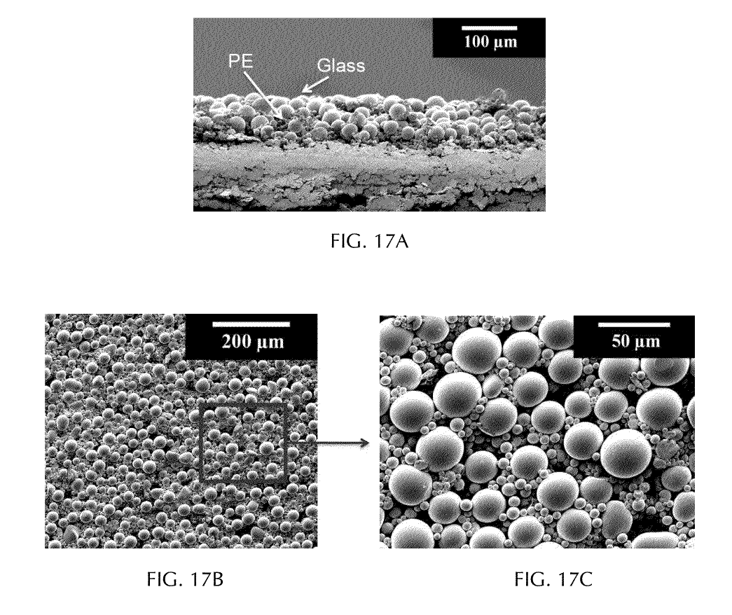

After drying, the coverage of glass spheres on the anode was ρ=2.55 mg cm⁻², and the coverage of PE particles on the anode was ρ=1.28 mg cm⁻². FIG. 17A depicts an edge-view SEM image of a coated anode, and identifies the larger glass spheres and the smaller PE particles. FIGS. 17B and 17C depict top-view SEM images of the coated anode, showing different magnifications.

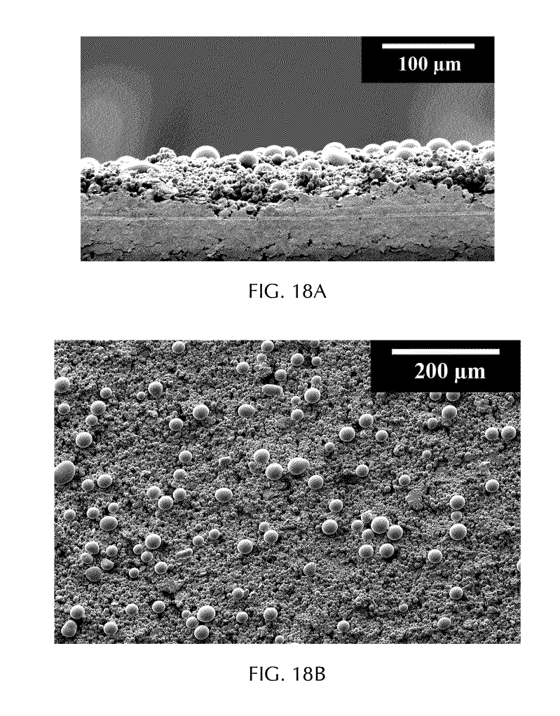

A second set of anodes coated with PE temperature-sensitive particles and thermally stable particles was prepared in a similar way, but using a particle suspension containing water, 0.1 grams of glass spheres having an average diameter of 25 micrometers, 0.2 grams of PE particles having a hydrophilic surface of Example 16, 0.5 wt % carboxymethyl cellulose, and 2.5 wt % Tween 20 surfactant. The suspension was stirred to ensure a homogenous dispersion of the binder, a portion of the suspension was deposited onto an anode disk, and the thickness of the suspension on the anode surface was reduced by passing a doctor blade over the surface at a height above the anode surface of approximately 76 micrometers. After drying, the coverage of glass spheres on the anode was ρ=0.81 mg cm⁻², and the coverage of PE particles on the anode was ρ=1.62 mg cm⁻². FIG. 18A depicts an edge-view SEM image of a coated anode, and FIG. 18B depicts a top-view SEM image of the coated anode.

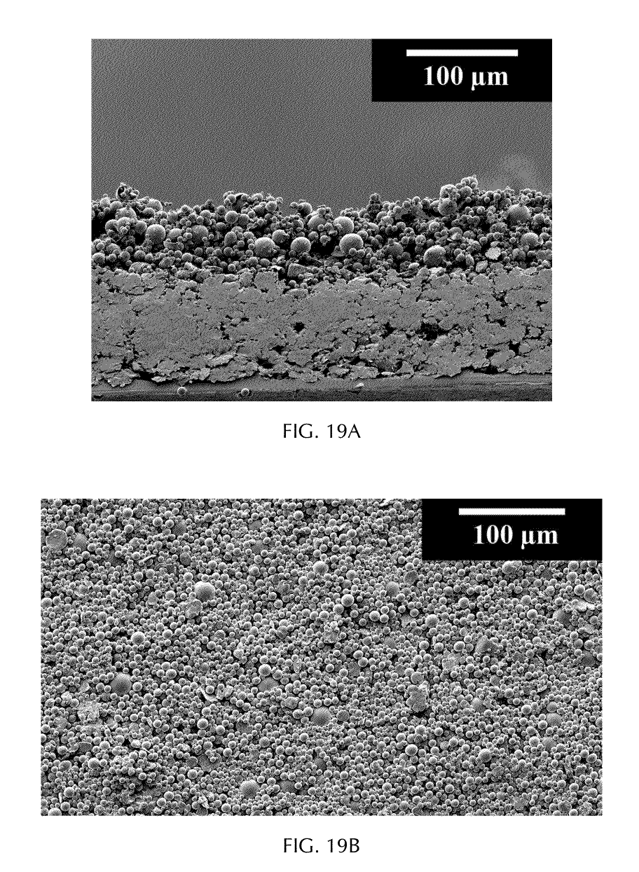

A third set of anodes coated with PE temperature-sensitive particles and thermally stable particles was prepared using a two-step deposition process. A first particle suspension was prepared by combining water, 10 wt % glass spheres having an average diameter of 25 micrometers, 0.5 wt % carboxymethyl cellulose, and 2.5 wt % Tween 20 surfactant. A second particle suspension was prepared by combining water, 20 wt % of PE particles having a hydrophilic surface of Example 16, 0.5 wt % carboxymethyl cellulose, and 2.5 wt % Tween 20 surfactant. The suspensions were stirred to ensure homogenous dispersions of the binders, a portion of the first suspension was deposited onto an anode disk, a portion of the second suspension was then deposited onto the anode disk, and the thickness of the combined depositions on the anode surface was reduced by passing a doctor blade over the surface at a height above the anode surface of approximately 76 micrometers. After drying, the coverage of glass spheres on the anode was ρ=1.36 mg cm⁻², and the coverage of PE particles on the anode was ρ=1.69 mg cm⁻². FIG. 19A depicts an edge-view SEM image of a coated anode, and FIG. 19B depicts a top-view SEM image of the coated anode.

### Example 19

### Assembly and Testing of Li-Ion Coin Cells Having Anodes Coated with Temperature-Sensitive Particles and with Thermally Stable Particles, but without a Separator

An anode was coated with PE temperature-sensitive particles and thermally stable particles according to Example 18, except that the coverage of glass spheres on the anode was ρ=4.4 mg cm⁻², and the coverage of PE particles on the anode was ρ=6.0 mg cm⁻². The anode was used to assemble a coin cell without a separator in an argon-filled glove box. The stacking sequence of the coin cell was the anode cap, spring, spacer, anode disk, 6 drops of 1.2 M LiPF₆ in ethylene carbonate:ethyl methyl carbonate (EC:EMC; ratio of 3:7) electrolyte, cathode disk (Li(Ni_{1/3}Co_{1/3}Mn_{1/3})O₂(Li333)), spacer, and top cap.

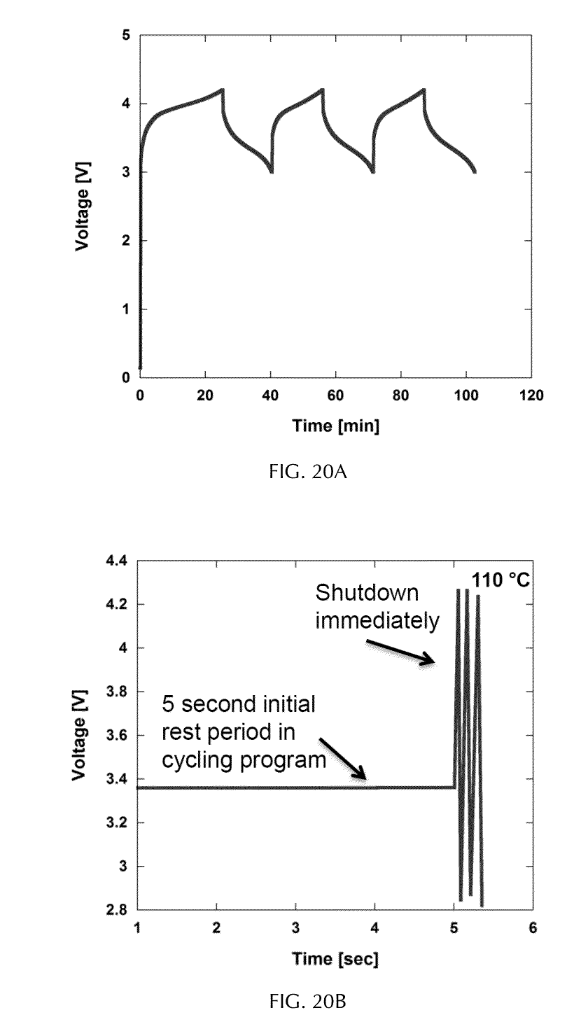

After assembly, the cell was removed from the glove box and mounted in a cycler test channel. The cell was cycled three times at room temperature (25° C.). The first cycle consisted of a constant charge at a current of +1.75 mA from 1 V to 4.2 V, followed by a discharge at a current of −1.75 mA from 4.2 V to 3 V. The remaining two cycles each consisted of a constant charge at a current of +1.75 mA from 3 V to 4.2 V, followed by a discharge at a current of −1.75 mA from 4.2 V to 3 V. The window of 3-4.2 V was selected based on the cathode material. FIG. 20A is a graph of voltage over time at 25° C. The charge capacity at 25° C. was 100 mA·h/g.

For thermal testing, the cycling program commenced 60 seconds after the cell was fully submerged in oil having a temperature of 110° C. The open circuit voltage of the cell was measured for 5 seconds, and then the same voltage cycling was applied. FIG. 20B is a graph of voltage over time at 110° C. The charge capacity at 110° C. was 0 mA·h/g, and shutdown was determined to have occurred within 0.4 seconds.

While various embodiments of the invention have been described, it will be apparent to those of ordinary skill in the art that other embodiments and implementations are possible within the scope of the invention. Accordingly, the invention is not to be restricted except in light of the attached claims and their equivalents.

What is claimed is:

1. An autonomous battery shutdown system, comprising:
a battery comprising an anode, a cathode, and an electrolyte composition between the anode and the cathode;
the electrolyte composition comprising an ionically conductive liquid comprising lithium ions, and a plurality of temperature-sensitive particles;
the temperature-sensitive particles comprising a polymer having a melting temperature between 60° C. and 120° C., and
the temperature-sensitive particles comprising a hydrophilic surface;
where, when the temperature of the battery exceeds 120° C., the temperature-sensitive particles form an ion barrier that traverses the battery.

2. The system of claim 1, where the temperature-sensitive particles are in contact with at least one of the anode and the cathode.

3. The system of claim 1, where the ion barrier comprises a polymer film.

4. The system of claim 1, where the temperature-sensitive particles comprise solid particles; and
where, when the temperature of the battery exceeds 120° C., the polymer melts and forms the ion barrier that traverses the battery.

5. The system of claim 4, where the polymer is selected from the group consisting of polyethylene and a wax.

6. The system of claim 4, where the polymer comprises polyethylene comprising dopamine on the particle surface.

7. The system of claim 1, where the temperature-sensitive particles comprise capsules comprising a capsule wall having a melting temperature between 60° C. and 120° C., and a barrier-forming agent enclosed by the capsule wall;
where, when the temperature of the battery exceeds 120° C., the capsule wall melts, the barrier-forming substance is released, and the released barrier-forming substance forms the ion barrier that traverses the battery.

8. The system of claim 7, where the barrier-forming substance comprises a polymerizer that forms a polymer film.

9. The system of claim 7, where
the electrolyte composition comprises a polymerizer, and
the barrier-forming substance comprises an activator for the polymerizer.

10. The system of claim 1, where, when the temperature of the battery exceeds 115° C., the temperature-sensitive particles form the ion barrier that traverses the battery.

11. The system of claim 1, where, when the temperature of the battery exceeds 110° C., the temperature-sensitive particles form the ion barrier that traverses the battery.

12. The system of claim 1, where the battery further comprises a separator that traverses the battery.

13. An autonomous battery shutdown system, comprising:
a battery comprising an anode, a cathode, and an electrolyte composition between the anode and the cathode;
the electrolyte composition comprising an ionically conductive liquid comprising lithium ions, and a plurality of capsules;
the capsules comprising a capsule wall having a melting temperature between 60° C. and 120° C., and a barrier-forming agent enclosed by the capsule wall;
where, when the temperature of the battery exceeds 120° C., the capsule wall melts, the barrier-forming substance is released, and the released barrier-forming substance forms an ion barrier that traverses the battery.

14. The system of claim 13, where the barrier-forming substance comprises a polymerizer that forms a polymer film.

15. The system of claim 13, where
the electrolyte composition comprises a polymerizer, and
the barrier-forming substance comprises an activator for the polymerizer.

16. The system of claim 13, where the battery further comprises a separator that traverses the battery.

17. An autonomous battery shutdown system, comprising:
a battery comprising an anode, a cathode, and an electrolyte composition between the anode and the cathode;
the electrolyte composition comprising
an ionically conductive liquid comprising lithium ions,
a plurality of temperature-sensitive particles comprising a first polymer having a melting temperature between 60° C. and 120° C., and
a plurality of thermally stable particles;
where, when the temperature of the battery exceeds 120° C., the temperature-sensitive particles form an ion barrier that traverses the battery.

18. The system of claim 17, where the thermally stable particles comprise a polymer having a glass transition temperature greater than 120° C.

19. The system of claim 17, where the thermally stable particles comprise a ceramic.

20. The system of claim 19, where the thermally stable particles comprise a glass.

21. The system of claim 17, where the ion barrier comprises a polymer film.

22. The system of claim 17, where the temperature-sensitive particles comprise solid particles; and
where, when the temperature of the battery exceeds 120° C., the polymer melts and forms the ion barrier that traverses the battery.

23. The system of claim 22, where the polymer is selected from the group consisting of polyethylene and a wax.

24. The system of claim 22, where the polymer comprises polyethylene

25. The system of claim 22, where the temperature-sensitive particles comprise dopamine on the particle surface.

26. The system of claim 17, where the temperature-sensitive particles comprise capsules comprising a capsule wall having a melting temperature between 60° C. and 120° C., and a barrier-forming agent enclosed by the capsule wall;
where, when the temperature of the battery exceeds 120° C., the capsule wall melts, the barrier-forming substance is released, and the released barrier-forming substance forms an ion barrier that traverses the battery.

27. The system of claim 26, where the barrier-forming substance comprises a polymerizer that forms a polymer film.

28. The system of claim 26, where
the electrolyte composition comprises a polymerizer, and
the barrier-forming substance comprises an activator for the polymerizer.
